(19) United States
(12) Patent Application Publication
(10) Pub. No.: US 2009/0037093 A1
(43) Pub. Date: Feb. 5, 2009

(54) Vehicle-Mounted Navigation Apparatus

(75) Inventors: Nobuaki Kurihara, Tokyo (JP); Yasutaka Koga, Tokyo (JP)

Correspondence Address: BIRCH STEWART KOLASCH & BIRCH, PO BOX 747, FALLS CHURCH, VA, 22040-0747, US

(73) Assignee: MITSUBISHI DENKI KABUSHIKI KAISHA, Tokyo (JP)

(21) Appl. No.: 11/919,636

(22) PCT Filed: Apr. 7, 2006
(86) PCT No.: PCT/JP2006/307495

§ 371 Date: Oct. 31, 2007

(30) Foreign Application Priority Data
Jun. 22, 2005 (JP) 2005-182335

(51) Int. Cl. G01C 21/36

(52) U.S. Cl. 701/201

(57) ABSTRACT

A vehicle-mounted navigation apparatus includes a traffic information acquiring means 10 for acquiring traffic information from outside the apparatus, a conditions setting means 16 for setting up conditions for filtering traffic information, a control means 14 for filtering the traffic information acquired by the traffic information acquiring means according to the conditions set up by the conditions setting means so as to extract traffic information according to the conditions, a list generating means 15 for generating a list on the basis of the traffic information extracted by the control means, and an output means 19 for outputting the list generated by the list generating means.

### FIELD OF THE INVENTION

The present invention relates to a vehicle-mounted navigation apparatus which is mounted in a vehicle so as to provide guidance for a user. More particularly, the present invention relates to a technology for outputting traffic information received from outside the vehicle-mounted navigation apparatus.

### BACKGROUND OF THE INVENTION

Conventionally, a vehicle-mounted navigation apparatus which notifies traffic information to a user of a vehicle for the user's convenience in driving is known. Such a vehicle-mounted navigation apparatus notifies all of traffic information which is related to a searched route which the apparatus has searched for by using a route searching function, out of traffic information received from outside the vehicle-mounted navigation apparatus, to the user, and re-searches for a route which avoids a traffic disturbance shown by this traffic information notified to the user.

As a technology relevant to such a vehicle-mounted navigation apparatus, patent reference 1 discloses a road traffic information display apparatus which receives road traffic information transmitted via FM multiplex broadcast, and which displays congestion information, accident information, etc. on a display device. When an ignition key is operated to an ACC position, this road traffic information display apparatus checks to see whether or not an information menu selecting switch has been operated first, and, when judging that the switch has been operated, displays an information menu screen. When either one of pieces of information shown is selected on this information menu screen, the type of the selected information is stored in a RAM. Next, when one road type is selected from the menu screen, if the type of information which should be displayed is already stored in the RAM, the road traffic information display apparatus displays information about the road type selected from the menu screen on the basis of the type of the information. Thereby, even if the road type is changed while route guidance is in progress, the road traffic information display apparatus can display information of the same type promptly. In contrast, when no information is stored in the RAM, the display is switched in the same sequence as usual.

Patent reference 2 discloses a vehicle-mounted navigation apparatus which enables a user to arbitrarily select either the type of a traffic information transmission medium or the type of the description of traffic information. This vehicle-mounted navigation apparatus has a function of receiving traffic information transmitted via two or more traffic information transmission media using a traffic information receiving unit, and generating a display which is based on the received traffic information, and a road map display according to a display device, makes the display unit display a menu screen in response to a user's operation of a menu screen display instruction switch, allows the user to specify the type of a traffic information transmission medium and the type of the description of traffic information from the display of the menu screen via a touch panel, and displays only the traffic information based on the traffic information transmission media and the description of traffic information which are specified, and a road map together on the display device.
[Patent reference 1] JP, 8-30895,A
[Patent reference 2] JP, 9-218045,A

Although the above-mentioned conventional vehicle-mounted navigation apparatus can select the types of traffic disturbances which the vehicle-mounted navigation apparatus will notify to the user, the vehicle-mounted navigation apparatus notifies many traffic disturbances at a time depending upon the types of traffic disturbances to be notified. Because all traffic information relevant to the searched route is notified to the user, many pieces of traffic information which do not have any influence upon the user are also included in this traffic information notified to the user. A problem is therefore that it is difficult for the user to distinguish important information from unnecessary information.

Furthermore, because the reliability of the traffic information received by the conventional vehicle-mounted navigation apparatus varies with the transmit source of the traffic information, the places where traffic disturbances occurred respectively, the time zone in which the traffic information is broadcasted, etc., information which is not effective for the user, like traffic information which is not the newest, may be included in the traffic information. In addition, although the conventional vehicle-mounted navigation apparatus can automatically search for a route which avoids traffic disturbances, because, as above mentioned, all traffic disturbances are displayed on the screen so that they are notified to the user, the guidance may be interrupted while the user is driving along the searched route, or the user may be forced to perform a certain operation.

The present invention is made in order to solve the above-mentioned problems, and it is therefore an object of the present invention to provide a vehicle-mounted navigation apparatus which can notify traffic information which the user desires to the user efficiently.

### DISCLOSURE OF THE INVENTION

In accordance with the present invention, there is provided a vehicle-mounted navigation apparatus provided with a position detecting means for detecting a position of a vehicle, an input means for inputting a destination, and a route searching unit for searching for a route from the vehicle's position detected by the position detecting means to the destination inputted by the input means, the navigation apparatus including: a traffic information acquiring means for acquiring traffic information from outside the apparatus; a conditions setting means for setting up conditions for filtering traffic information; a control means for filtering the traffic information acquired by the traffic information acquiring means according to the conditions set up by the conditions setting means so as to extract traffic information according to the conditions; a list generating means for generating a list on a basis of the traffic information extracted by the control means; and an output means for outputting the list generated by the list generating means.

According to the present invention, when the user sets up conditions for filtering the traffic information by using the conditions setting means, the vehicle-mounted navigation apparatus generates a list of traffic information by filtering the traffic information acquired by the traffic information acquiring means according to the conditions set up by the conditions setting means, and outputs the list. Therefore, the vehicle-mounted navigation apparatus can notify the user of traffic information which the user desires, i.e., traffic information important for the user efficiently.

### BRIEF DESCRIPTION OF THE FIGURES

FIG. 1 is a block diagram showing the structure of a vehicle-mounted navigation apparatus in accordance with Embodiment 1 of the present invention;

FIG. 2 is a drawing showing an example of a traffic information setting menu for use in the vehicle-mounted navigation apparatus in accordance with Embodiment 1 of the present invention;

FIG. 3 is a drawing showing an example of a traffic information searching conditions setting screen which is displayed when “traffic information searching conditions (filter)” is selected in the traffic information setting menu shown in FIG. 2;

FIG. 4 is a drawing showing an example of a disturbance non-notification conditions setting screen which is displayed when “disturbance non-notification conditions setting” is selected in the traffic information set menu shown in FIG. 2;

FIG. 5 is a drawing showing an example of a notification and display order setting screen which is displayed when “notification and display order setting” is selected in the traffic information set menu shown in FIG. 2;

FIG. 6 is a drawing showing an example of a filter setting screen for traffic information transmit sources which is displayed when “navigation: filter for traffic information transmit sources” is selected in the traffic information set menu shown in FIG. 2;

FIG. 7 is a flow chart showing the operation of the vehicle-mounted navigation apparatus in accordance with Embodiment 1 of the present invention;

FIG. 8 is a drawing showing an example of a route guidance screen in the vehicle-mounted navigation apparatus in accordance with Embodiment 1 of the present invention;

FIG. 9 is a drawing showing an example of an automatic traffic information notification screen in the vehicle-mounted navigation apparatus in accordance with Embodiment 1 of the present invention;

FIG. 10 is a drawing showing an example of a display of an on-route traffic disturbance list in the vehicle-mounted navigation apparatus in accordance with Embodiment 1 of the present invention;

FIG. 11 is a drawing showing an example of a display of symbols indicating traffic disturbances for use in the vehicle-mounted navigation apparatus in accordance with Embodiment 1 of the present invention; and

FIG. 12 is a drawing showing an example of a display of the symbols indicating traffic disturbances on a map in the vehicle-mounted navigation apparatus in accordance with Embodiment 1 of the present invention.

### PREFERRED EMBODIMENT OF THE INVENTION

Hereafter, in order to explain this invention in greater detail, the preferred embodiment of the present invention will be described with reference to the accompanying drawings. Embodiment 1.

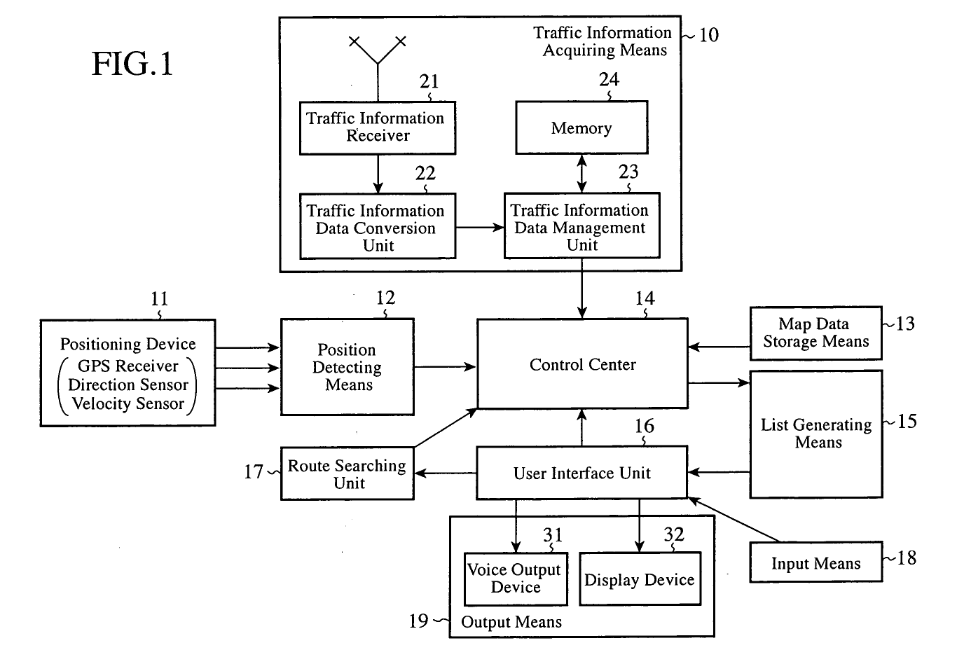

FIG. 1 is a block diagram showing the structure of a vehicle-mounted navigation apparatus in accordance with Embodiment 1 of the present invention. This vehicle-mounted navigation apparatus is comprised of a traffic information acquiring means 10, a positioning device 11, a position detecting means 12, a map data storage means 13, a control center 14, a list generating means 15, a user interface unit 16, a route searching unit 17, an input means 18, and an output means 19.

The traffic information acquiring means 10 acquires traffic information from a transmit source, such as an external traffic information broadcasting station intended for navigation or a traffic information broadcasting station intended for radios, and sends the traffic information to the control center 14. A description, a degree of influence, and an occurrence location of a traffic disturbance are included in this traffic information. The description of a traffic disturbance includes the length (or distance), the time of occurrence, etc. of the traffic disturbance. The degree of influence of a traffic disturbance shows the magnitude of the influence which the traffic disturbance will exert upon the user, and is shown by, for example, a level ranging from 1 to 10. The occurrence location of a traffic disturbance shows the location where the traffic disturbance occurred, and is shown by, for example, the latitude and longitude of the location.

This traffic information acquiring means 10 is comprised of a traffic information receiver 21, a traffic information data conversion unit 22, a traffic information data management unit 23, and a memory 24. The traffic information receiver 21 receives a signal indicating traffic information sent from outside the navigation apparatus (a transmit source). The signal received by this traffic information receiver 21 is sent to the traffic information data conversion unit 22. The traffic information data conversion unit 22 converts the signal sent from the traffic information receiver 21 into traffic information data. The traffic information data acquired by this traffic information data conversion unit 22 are sent to the traffic information data management unit 23.

The traffic information data management unit 23 receives the traffic information data sent from the traffic information data conversion unit 22 and stores the data in the memory 24, and also sends the data to the control center 14 as needed. The traffic information data management unit 23 reads the traffic information data from the memory 24 in response to a request from the control center 14, and sends the data to this control center 14. The memory 24 stores the traffic information data as mentioned above.

The positioning device 11 is comprised of, for example, a GPS (Global Positioning System) receiver, a direction sensor, and a velocity sensor. GPS data acquired by the GPS receiver which constructs this positioning device 11, direction data acquired by the direction sensor which constructs this positioning device 11, and vehicle velocity data acquired by the velocity sensor which constructs this positioning device 11 are sent to the position detecting means 12 as positioning data. The position detecting means 12 detects its current position on the basis of the positioning data sent from the positioning device 11. The current position data indicating the current position detected by this position detecting means 12 is sent to the control center 14.

The map data storage means 13 is comprised of, for example, a DVD (Digital Versatile Disk), a CD (Compact Disc), a hard disk (HDD: Hard Disk Drive), or the like, and stores map data therein. The map data stored in this map data storage means 13 are read by the control center 14, and are provided for a map display by the display device 32 and route searching by the route searching unit 17.

The control center 14 corresponds to a control means of the present invention, and controls the whole of the vehicle-mounted navigation apparatus. For example, the control center 14 performs filtering on a traffic disturbance indicated by the traffic information data sent from the traffic information acquiring means 10 on the basis of the current position data sent from the position detecting means 12, the map data sent from the map data storage means 13, and input data sent from the input means via the user interface unit 16, and sends traffic information data indicating the traffic disturbance, which are extracted through this filtering, to the list generating means 15. The details of this control center 14 will be mentioned later.

The list generating means 15 acquires traffic information data indicating traffic disturbances which exist around the vehicle or the route from the control center 14, generates a symbol indicating the type of each of the traffic disturbances, detailed information about each of the traffic disturbances, the positions of the traffic disturbances on a map, and a list of the traffic disturbances, and sends them to the user interface unit 16.

The user interface unit 16 is used in order for the user to communicate with the vehicle-mounted navigation apparatus. This user interface unit 16 carries out setting of the filter, a selection of a display method, etc. according to the input data from the input means 18. Conditions which the user sets up with this user interface unit 16 are sent to the control center 14. The control center 14 selects a traffic disturbance which is to be notified to the user on the basis of the conditions.

The route searching unit 17 carries out an avoidance searching process of searching for a route which avoids the occurrence locations of traffic disturbances shown by the traffic information in response to an avoidance searching start instruction sent from the user interface unit 16. Data indicating the route which this route searching unit 17 has searched for are sent to the control center 14. This route searching unit 17 also carries out a general route searching process, i.e., a process of searching for a route from the current position detected by the position detecting means 12 to a destination inputted by the input means 18.

The input means 18 is comprised of, for example, a remote controller, buttons on a face panel, a voice recognition unit, etc., and is used by the user when the user presses down a button formed in each of various screens for allowing the user to set up a destination for the route searching and to set up conditions under which the traffic information is filtered. Input data inputted from this input means 18 are sent to the user interface unit 16.

The output means 19 is comprised of a voice output device 31 and a display device 32. The voice output device 31 is comprised of, for example, a speaker, and notifies the traffic disturbances notified from the user interface unit 16 to the user with a sound. The display device 32 is comprised of, for example, a liquid crystal display monitor, and notifies the traffic disturbances notified from the user interface unit 16 to the user with a screen display. This display device 32, as will be mentioned later in detail, displays various screens for allowing the user to set up conditions under which the traffic information is filtered.

Next, a screen which the user uses in order to set up a filter in this vehicle-mounted navigation apparatus will be explained.

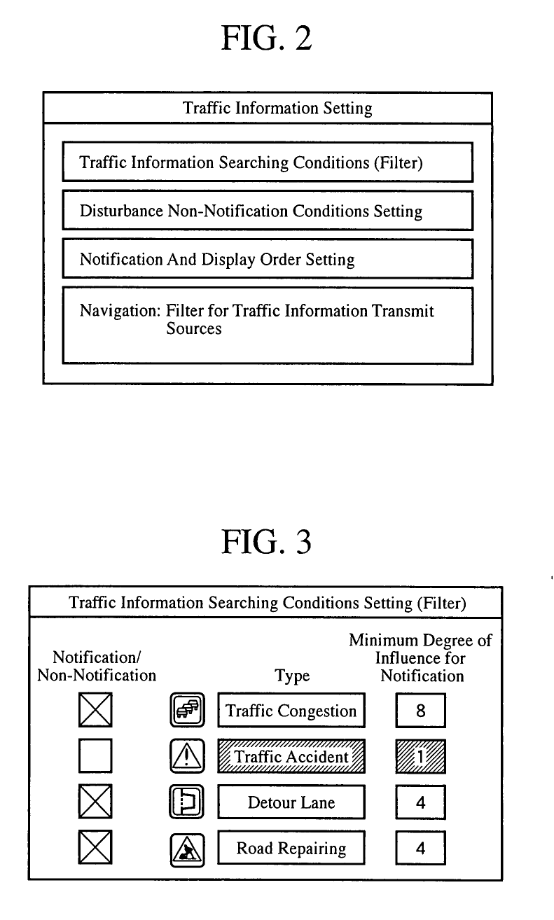

FIG. 2 shows an example of a traffic information setting menu. This traffic information setting menu has items including “traffic information searching conditions (filter)”, “disturbance non-notification conditions setting”, “notification and display order setting”, and “navigation: filter for traffic information transmit sources”, and enables the user to select one item arbitrarily therefrom.

FIG. 3 shows an example of a traffic information searching conditions setting screen which is displayed when the “traffic information searching conditions (filter)” is selected in the traffic information set menu shown in FIG. 2. The user sets up the type and the minimum degree of influence of each of traffic disturbances which the user desires the navigation apparatus to notify to him or her using this traffic information searching conditions setting screen.

The traffic information searching conditions setting screen is comprised of items including “notification/non-notification”, “type”, and “minimum degree of influence for notification.” Each “type” item shows the type of a traffic disturbance with a symbol or a character string, and can be, for example, traffic congestion, traffic accident, detour lane, or road repairing. Each “notification/non-notification” item is used in order to specify whether to notify a traffic disturbance shown in the corresponding “type” item to the user. Each “minimum degree of influence for notification” item is used in order for the user to specify a minimum value of the degree of influence of a traffic disturbance which the user desires the navigation apparatus to notify to him or her.

When the check mark of the “notification/non-notification” item of a traffic disturbance is unmarked, no notification of the traffic disturbance is provided even if the degree of influence of the traffic disturbance included in the received traffic information has exceeded its “minimum degree of influence for notification.” In the example shown in FIG. 3, no notification of “traffic accident” is provided. When the check marks of the “notification/non-notification” items of some traffic disturbances are marked, only some types of traffic disturbances which satisfy their set-up minimum degrees of influence are notified to the user. That is, when the degree of influence of a traffic disturbance included in the received traffic information is lower than its minimum degree of influence set up by the user, the user is not notified of the traffic disturbance (in the list display). By default, all the “notification/non-notification” items are checked and their minimum degrees of influence are all set to “1” so that notification of all the traffic disturbances is provided.

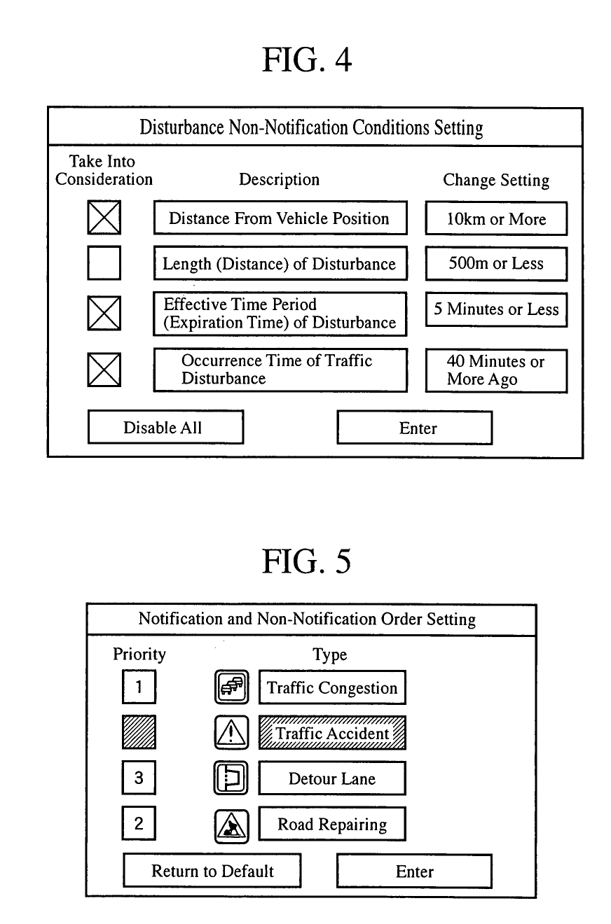

FIG. 4 shows an example of a disturbance non-notification conditions setting screen which is displayed when the “disturbance non-notification condition setting” is selected in the traffic information set menu shown in FIG. 2.

The disturbance non-notification conditions setting screen is comprised of items including “take into consideration”, “description”, “change setting”, “disable all”, and “enter.” Each “description” item shows the description of a traffic disturbance, and can be a distance from the vehicle's position, the length (distance) of the traffic disturbance, and the occurrence time of the traffic disturbance. Each “take into consideration” item is used in order for the user to specify whether or not the description shown in the corresponding “description” item is taken into consideration. The setting of each condition is enabled by checking the corresponding “take into consideration” item, whereas the setting is disabled by unmarking the check mark. Each “change setting” item is used in order for the user to change a value shown by the corresponding “description” item. The “disable all” item is used in order for the user to unmark the check marks of all the “taken into consideration” items. The “enter” item is used in order for the user to, when changing the value of the “change setting” item of a condition, confirm the changed value.

Even if the traffic information searching conditions set up using the traffic information searching conditions setting screen shown in FIG. 3 are satisfied, if all the disturbance non-notification conditions set up using the disturbance non-notification conditions setting screen shown in FIG. 4 are satisfied, no notification of all the traffic disturbances is provided (all the traffic disturbances are filtered).

Because the traffic information transmitted from outside the navigation apparatus (a transmit source) is unrelated to the user's current position (the vehicle position), there is a case that even if a traffic disturbance has a high degree of influence which is set up by the transmit side, the traffic disturbance has a low degree of influence upon the user. For example, when the vehicle is travelling toward a traffic disturbance at a distance of 100 km or less forward thereof which occurred 1 hour ago, it is unknown how the user will receive the influence of the traffic disturbance when reaching the location where the traffic disturbance occurred. By allowing the user to set up parameters, such as a distance from the vehicle position to the location where the traffic disturbance occurred, and the occurrence time of the traffic disturbance (or a time when the information about the traffic disturbance is updated to the latest information), it is possible to customize the notified information in such a manner that it is most suitable for the user.

FIG. 5 shows an example of a notification and display order setting screen which is displayed when the “notification and display order setting” is selected in the traffic information setting menu shown in FIG. 2.

The notification and display order setting screen is comprised of items including “priority”, “type”, “return to default”, and “enter.” Each “type” item is the same as that shown in FIG. 3. Each “priority” item is used in order for the user to change a priority given to a traffic disturbance shown in the corresponding “type” item. This priority item is used in order to determine the order in which the types of traffic disturbances are aligned in the case of displaying the traffic disturbance list as shown in, for example, FIG. 10. The “return to default” item is used in order to return the “priority” of each type of traffic disturbance to its default. When the “priority” of a type of traffic disturbance is changed, “enter” is used in order to confirm the changed value.

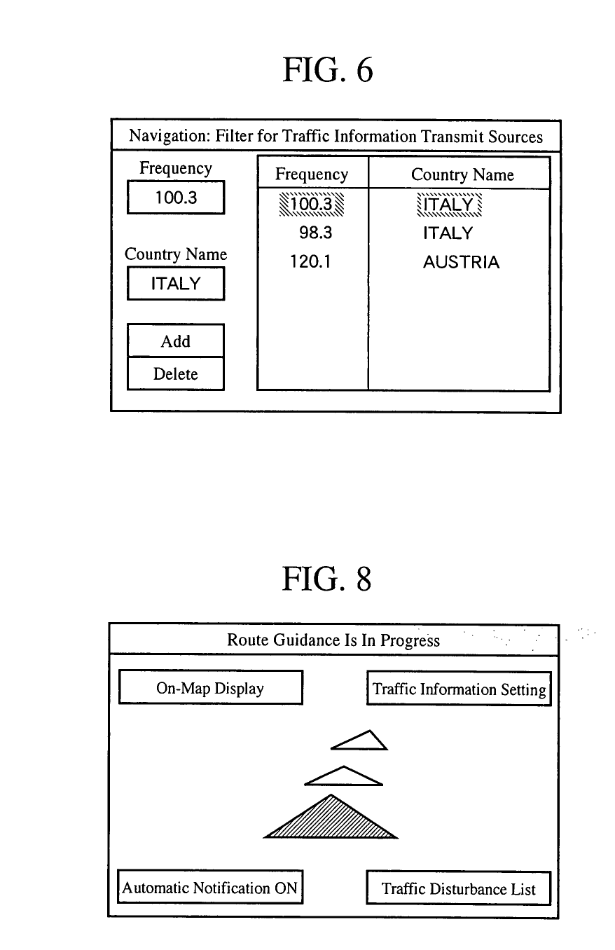

FIG. 6 shows an example of a filter setting screen for traffic information transmit sources which is displayed when the “navigation: filter for traffic information transmit sources” is selected in the traffic information setting menu shown in FIG. 2. As a transmit source of traffic information, a traffic information broadcasting station intended for radios other than a traffic information broadcasting station intended for navigation can also be used.

The filter setting screen for traffic information transmit sources is comprised of items including “frequency”, “country name”, “add”, and “delete.” The “frequency” item specifies a frequency at which reception of any traffic information from a transmit source is refused. The “country name” item specifies the name of a country in which the transmit source from which reception of any traffic information is refused is located. The “add” item is used in order to add the transmit source specified by the “frequency” item and the “country name” item as a broadcasting station from which reception of any traffic information is refused. The “delete” item is used in order to delete the transmit source specified by the “frequency” item and the “country name” item from a list of broadcasting stations from each of which reception of any traffic information is refused. By setting up a frequency and a country name for a transmit source using this filter setting screen for traffic information transmit sources, reception of any traffic information transmitted from the specific transmit source can be refused.

Conventional vehicle-mounted navigation apparatuses are so constructed as to, when receiving traffic information, check a specific code (common to all transmit sources) included in the received data in order to judge whether the transmit source of the traffic information has transmitted effective traffic information. However, there is a case that a transmit source transmits a code indicating that effective traffic information is included therein even though the transmit source does not transmit any traffic information at all. In this case, because no effective traffic information is transmitted, when judging that no traffic information which is to be notified to the user does not exist, the navigation apparatus can switch to reception of data from another transmit source, but has to carry out an excessive process for the switching. When switching to another transmit source so as to receive data from the new transmit source, in an environment where an AF (Alternate frequency: one broadcasting station has two or more frequencies) broadcasting station exists, the navigation apparatus may receive data again from the transmit source which is the same as that from which the navigation apparatus received data before the switching.

In a conventional vehicle-mounted navigation apparatus, it takes several minutes to notify data from a transmit source which has transmitted traffic information to the user after receiving the data, and this elapsed time is close to its limit below which it cannot be reduced from the viewpoint of the functions of the apparatus, but it is necessary to notify newer information to the user more quickly because the information is traffic information. Therefore, although it can be considered that the navigation apparatus is so configured as to receive only data from a desired transmit source, settings for this configuration are difficult because conditions differ from country to country, for example, two or more transmit sources can exist in each country or each area and a transmit source without charge and a transmit source with charge (traffic information from this transmit source can be used only when a contract with the transmit source is signed) can coexist. Therefore, because the navigation apparatus is so constructed as to enable the user to select a transmit source from which the user desires to refuse reception of any traffic information, as mentioned above, the navigation apparatus can reduce the frequency with which notification of useless information (delayed information and wrong information) is provided thereto, and can improve the possibility of receiving traffic information from transmit sources which can be assumed to be effective as much as possible.

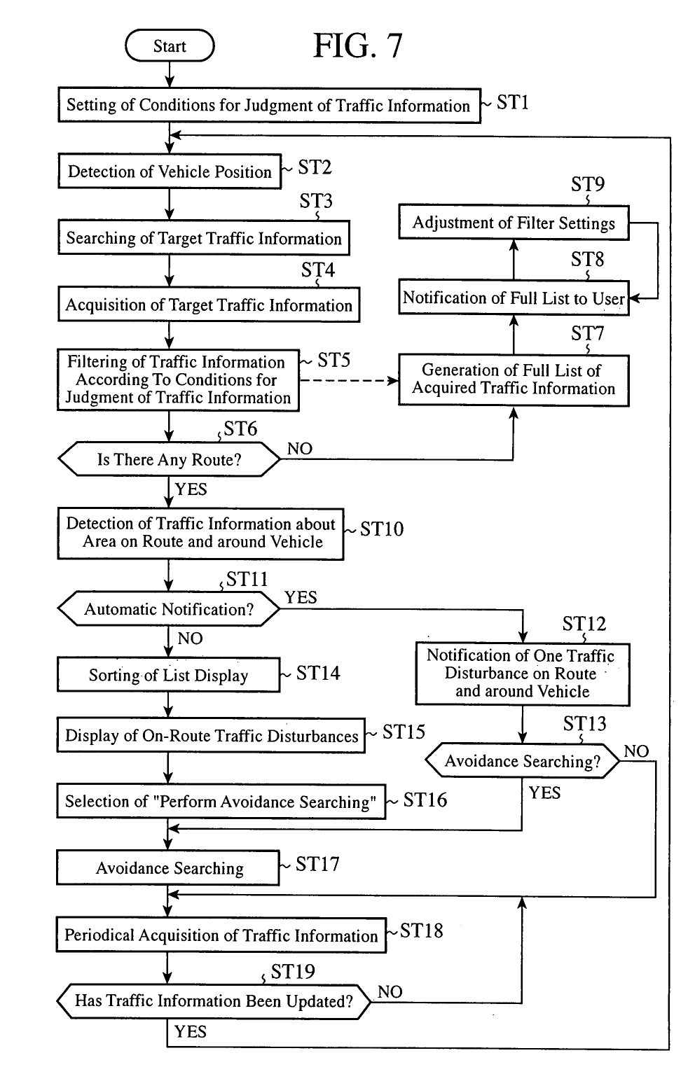

Next, the operation of the vehicle-mounted navigation apparatus in accordance with Embodiment 1 of the present invention which is constructed as mentioned above will be explained with reference to a flow chart shown in FIG. 7.

When starting route guidance, the vehicle-mounted navigation apparatus outputs a route guidance screen as shown in FIG. 8 to the display device 32. In this route guidance screen, an on-map display button, a traffic information setting button, an automatic notification ON button, and a traffic disturbance list button are disposed in addition to a map. The on-map display button is used in order to display a detected traffic disturbance on the map. The traffic information setting button is used in order to display the traffic information setting menu as shown in FIG. 2. The automatic notification ON button is used in order to enable an automatic notification of traffic disturbances. The traffic disturbance list button corresponds to an output specifying means of the present invention, and is used in order to make the detected traffic disturbance display in a list.

In a state in which the screen shown in FIG. 8 is displayed, conditions for judgment of traffic information are set up first (step ST1). More specifically, the user causes the navigation apparatus to display the traffic information setting menu as shown in FIG. 2 by operating the input means 18. The user then selects “traffic information searching conditions (filter)”, “disturbance non-notification conditions setting”, “notification and display order setting”, or “navigation: filter for traffic information transmit sources” as needed so as to set up traffic information searching conditions, disturbance non-notification conditions, notification and display order, or filtering conditions for traffic information transmit sources, which are mentioned above.

A detection of the vehicle position is then carried out (step ST2). More specifically, the position detecting means 12 acquires the positioning data from the positioning device 11, and calculates the current position of the vehicle. Then, the position detecting means sends the current position data indicating the calculated current position to the control center 14. As a result, the vehicle position and the destination are determined, and a route which has to be searched for is clarified. Assume that the destination is beforehand set up by using a well-known method.

Target traffic information which is traffic information having a predetermined relation with the vehicle is then searched for (step ST3), and the target traffic information is acquired (step ST4). More specifically, the traffic information data management unit 23 searches through either the traffic information data stored in the memory 24 or the traffic information data sent thereto via the traffic information data conversion unit 22 from the traffic information receiver 21 so as to acquire the target traffic information. The traffic information data management unit then sends this acquired traffic information to the control center 14.

The traffic information acquired in step ST4 is then filtered according to the conditions for judgment of traffic information which are set up in step ST1 (step ST5). More specifically, the control center 14 extracts only traffic information which satisfies the conditions set up in step ST1. Therefore, in this stage, traffic information unnecessary for the user is thrown away. The function of extracting traffic information according to the conditions for judgment of traffic information is referred to as a filtering function. The navigation apparatus can be constructed in such a manner as to list traffic disturbances shown by the traffic information which is filtered according to the conditions for judgment of traffic information, or to display the traffic disturbances on a map.

The navigation apparatus then checks to see whether or not there is any route which has been searched for by the route searching unit 17 (step ST6). When, in this step ST16, judging that there is no route which has been searched for by the route searching unit, the navigation apparatus generates a full list of the traffic disturbances shown by the acquired traffic information (step ST7). The user is then notified of this generated traffic information (the traffic disturbances) (step ST8). After that, the filter setting is adjusted using the traffic information setting menu (step ST9), and the notification of the traffic information to the user (step ST8) and the adjustment of the filter setting (step ST9) are then carried out repeatedly, so that the display device 32 is controlled in such a manner that only the traffic information which the user desires is displayed on the display device 32.

When, in above-mentioned step ST6, it is judged that there is a route which has been searched for, traffic disturbances shown by traffic information about a predetermined area on the route which has been searched for by the route searching unit 17 or around the vehicle, i.e., a predetermined area extending from the vehicle position detected by the position detecting means 12 are detected (step ST10). In this case, a predetermined area extending in the traveling direction of the vehicle forward of the vehicle position detected by the position detecting means 12 can be defined, as the predetermined area around the vehicle, by using the direction data acquired from the positioning device 11.

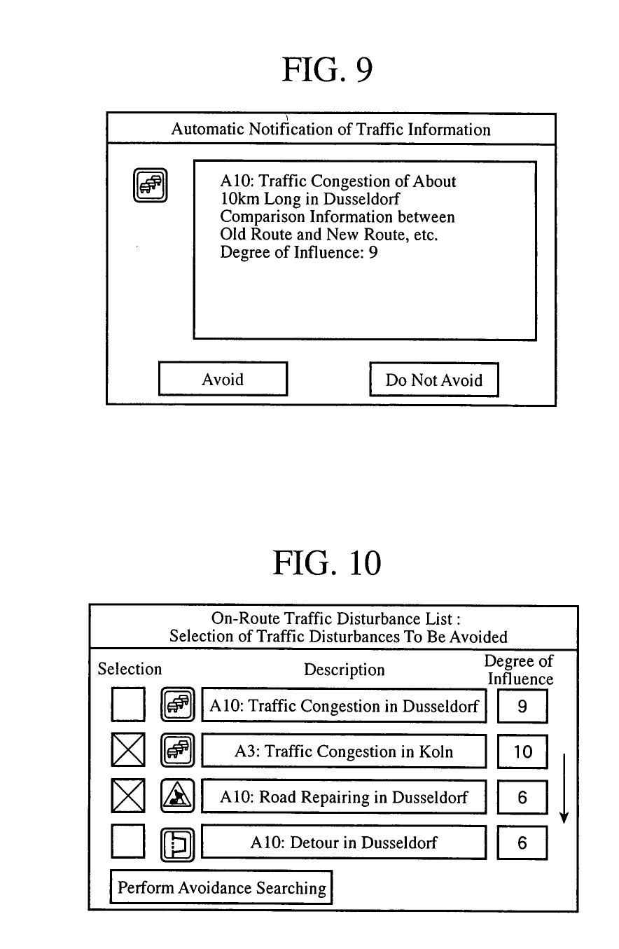

Whether or not the navigation apparatus is placed in the automatic notification mode, i.e., whether or not the “automatic notification ON button” of the route guidance screen as shown in FIG. 8 is turned on is checked to see (step ST11). When, in this step ST11, it is judged that the navigation apparatus is placed in the automatic notification mode, a traffic disturbance on the route or around the vehicle, which has been detected in above-mentioned step ST10, is notified (step ST12). This function of notifying a traffic disturbance is referred to as an automatic notification function. The notification of a traffic disturbance is carried out by displaying an automatic traffic information notification screen as shown in, for example, FIG. 9 on the display device 32. In this automatic traffic information notification screen, an “avoid” button and a “do not avoid” button are included in addition to a symbol indicating the type of the traffic disturbance and a message indicating the description of the traffic disturbance.

In the automatic notification function, a notification of one traffic disturbance is provided. Because this automatic notification function is started every time when a traffic disturbance is detected, a state in which the route guidance is interrupted occurs. Furthermore, because a notification of a traffic disturbance which is of low importance to the user is also made, it is not preferable to use the automatic notification function except when the automatic notification function is especially required. By making a traffic disturbance which is of low importance to the user be out of the target for the automatic notification by using the filtering function, the number of times that a traffic disturbance is notified to the user can be reduced.

Whether to carry out an avoidance searching is then checked to see (step ST13). More specifically, whether either the “avoid” button or the “do not avoid” button is pushed down is checked to see. When, in this step ST13, it is judged that an avoidance searching will be carried out, i.e., the “avoid” button has been pushed down, the sequence advances to step ST17 in which an avoidance searching is carried out. In contrast, when, in step ST13, it is judged that an avoidance searching will be not carried out, i.e., the “do not avoid” button has been pushed down, the sequence advances to step ST18 in which a periodical update of the traffic information is carried out.

When, in above-mentioned step ST11, it is judged that the navigation apparatus is not placed in the automatic notification mode, the list display is sorted (step ST14). More specifically, the traffic disturbances detected in step ST10 are rearranged according to the priorities set up in the notification and display order setting screen as shown in FIG. 5. In this state, when the user pushes down the traffic disturbance list button on the screen in order to check the traffic disturbances, the traffic disturbances on the route are displayed (step ST15). This display of the traffic disturbances on the route is carried out by either displaying the symbols of the traffic disturbances on the route which is drawn on the map, as shown in, for example, FIG. 12(a), or displaying the on-route traffic disturbance list as shown in FIG. 10. Whether the traffic disturbances are displayed in either one of the formats is determined by how the on-map display button and the traffic disturbance list button are pushed down.

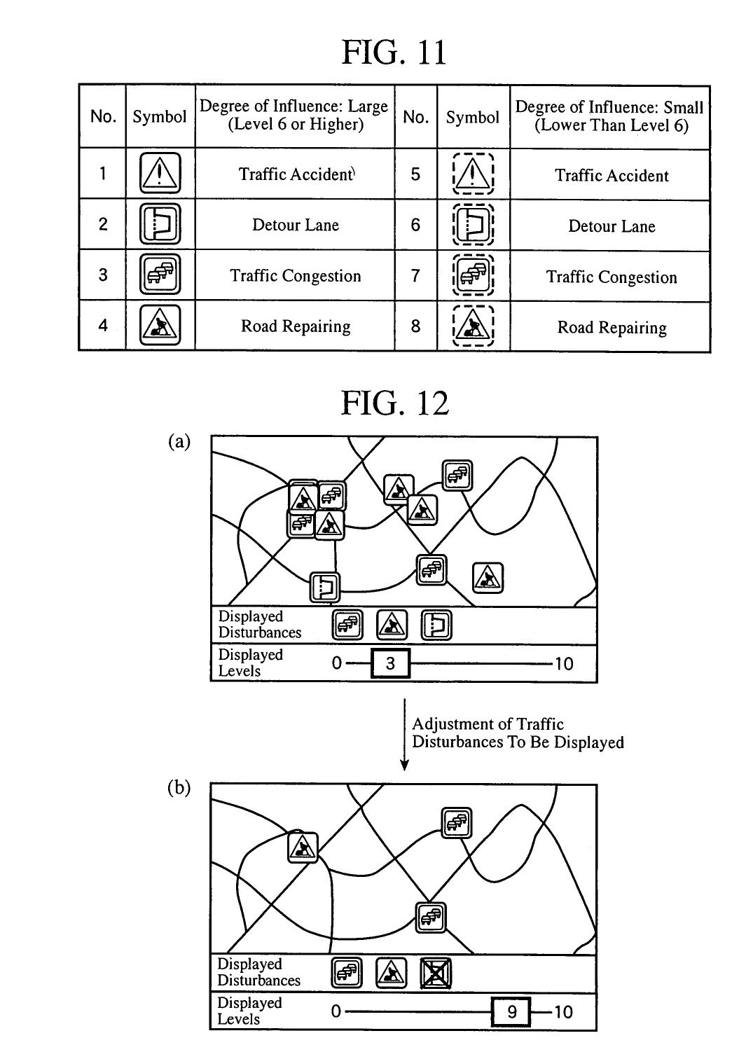

When listing the traffic disturbances on the route, a list of the traffic disturbances on the route, as shown in FIG. 10, is displayed on the display device 32. This on-route traffic disturbance list screen has items including “selection”, “description”, “degree of influence”, and “perform avoidance searching”. Each “description” item is comprised of a symbol indicating the type of a traffic disturbance, and a message indicating the description of the traffic disturbance. In this case, as shown in FIG. 11, the symbol is color-coded according to its degree of influence. For example, in a case in which the traffic disturbance has a large degree of influence (level 6 or higher), the symbol can be shown in such a manner as to have a red frame, and, in a case in which the traffic disturbance has a small degree of influence (level lower than level 6), the symbol can be shown in such a manner as to have a yellow frame. This structure can enhance the user's recognition of the importance of each traffic disturbance.

The user can select two or more traffic disturbances from the list of traffic disturbances on the route by checking the corresponding two or more “selection” items, and can cause the navigation apparatus to carry out an avoidance searching by pushing down the “perform avoidance searching” button. Generally, in the case in which the traffic disturbances are listed, it takes time and effort for the user to check effective information from the list of traffic disturbances on the route because the screen display region has a limited size. However, a notification of only information effective for the user can be provided by making traffic disturbances of low importance for the user be out of the target for the list display by using the filtering function.

When the “perform avoidance searching” button is selected in a state in which this list of traffic disturbances on the route is displayed (step ST16), an avoidance searching is then carried out (step ST17). The route searching unit 17 re-searches through routes from the current position to the destination for a route which avoids the traffic disturbances for which the corresponding “selection” items on the screen of the on-route traffic disturbance list shown in FIG. 10 are checked. As a result, an image in which the new route is drawn on the map is displayed on the display device 32.

A periodical traffic information acquisition is then carried out (step ST18). Whether or not the traffic information has been updated is further checked to see (step ST19). When, in this step ST19, it is judged that the traffic information has not been updated, the sequence returns to step ST18 in which the processes of step ST18 and ST19 are repeated until the traffic information is updated. When, in step ST19, it is then judged that the traffic information has been updated, the sequence returns to step ST2 in which the above-mentioned processes are repeated.

In the case of displaying the traffic disturbances on the route by displaying the symbols of the traffic disturbances on the route which is drawn on the map, the navigation apparatus can be constructed in such a manner that the user is allowed to operate a display level bar to limit the traffic disturbances (the symbols) to be displayed. In the case of enabling the user to check the traffic disturbances by displaying them on a map, because there is a higher possibility that the symbols of the traffic disturbances overlap one another as the scale of the map increases, the user is enabled to check only important traffic information by allowing the user to perform setting of the types of traffic disturbances which can be displayed and to perform an adjustment of such levels as the degrees of influence of traffic disturbances which can be displayed during the display of the map. In a case of carrying out a searching of a long-distance route, the navigation apparatus enables the user to check the traffic information while displaying the whole of the searched route, and therefore can eliminate the necessity for the user to adjust the scale of the displayed map in order to check the traffic disturbances.

As previously explained, because the vehicle-mounted navigation apparatus in accordance with Embodiment 1 of the present invention, when the user sets up conditions for filtering traffic information with the input means 18, generates a list which consists of the traffic information filtered according to the set-up conditions from traffic information acquired by the traffic information acquiring means 10, and outputs the list, the vehicle-mounted navigation apparatus can notify the user of traffic information which the user desires, i.e., traffic information important for the user efficiently.

Because the vehicle-mounted navigation apparatus is so constructed as to express traffic disturbances with symbols which differ according to the types, degrees of influence, and so on of the traffic disturbances when conditions for the filter are set up, the user can recognize the traffic disturbances easily. Furthermore, because an automatic avoidance searching is carried out in such a manner that only traffic disturbances important for the user are avoided, a route suitable for the user can be provided for the user.

In a setup of traffic information searching conditions, the notification/non-notification of each traffic disturbance is controlled in consideration of the type and minimum degree of influence of each traffic disturbance shown by the traffic information. The notification/non-notification of each traffic disturbance can be alternatively controlled in consideration of the location, time, distance, and so on of each traffic disturbance. With this structure, the efficiency of provision of information about traffic disturbances can be improved.

### INDUSTRIAL APPLICABILITY

The present invention is widely applicable to a road traffic information display apparatus for use in a car-navigation system and so on.

1. A vehicle-mounted navigation apparatus provided with a position detecting means for detecting a position of a vehicle,
an input means for inputting a destination, and
a route searching unit for searching for a route from the vehicle position detected by said position detecting means to the destination inputted by said input means, said navigation apparatus comprising:
a traffic information acquiring means for acquiring traffic information from outside the apparatus;
a conditions setting means for setting up conditions for filtering traffic information;
a control means for filtering the traffic information acquired by said traffic information acquiring means according to the conditions set up by said conditions setting means so as to extract traffic information according to said conditions;
a list generating means for generating a list on a basis of the traffic information extracted by said control means; and
an output means for outputting the list generated by said list generating means.

2. The vehicle-mounted navigation apparatus according to claim 1, characterized in that the route searching unit searches for a route which avoids a location of occurrence of a traffic disturbance shown by traffic information selected from the list generated by the list generating means.

3. The vehicle-mounted navigation apparatus according to claim 1, characterized in that the conditioning means sets up a minimum degree of influence which is used as a criterion of judgment of a notification of a traffic disturbance, and, when a degree of influence included in the traffic information acquired by the traffic information acquiring means is larger than the minimum degree of influence set up by said conditions setting means, the control means extracts this traffic information.

4. The vehicle-mounted navigation apparatus according to claim 1, characterized in that the conditions setting means assigns a priority to each type of traffic disturbance, and the list generating means generates a list of sorted traffic information according to priorities assigned by said conditions setting means.

5. The vehicle-mounted navigation apparatus according to claim 1, characterized in that the conditions setting means determines a transmit source from which the traffic information acquiring means refuses to acquire any traffic information, and the control means extracts traffic information excluding traffic information from the transmit source determined by said conditions setting means.

6. The vehicle-mounted navigation apparatus according to claim 1, characterized in that the traffic information acquiring means acquires traffic information from outside the navigation apparatus at regular intervals, and, when the traffic information acquired by said traffic information acquiring means is updated, the control means filters this updated traffic information according to the conditions set up by said conditions setting means so as to extract traffic information according to these conditions and the list generating means updates the list on a basis of the traffic information extracted by said control means.

7. The vehicle-mounted navigation apparatus according to claim 6, characterized in that every time when the list is updated by said list generating means, the route searching unit searches for a route which avoids a location of occurrence of a traffic disturbance shown by traffic information selected from said updated list.

8. The vehicle-mounted navigation apparatus according to claim 1, characterized in that said navigation apparatus comprises an output instruction means for providing an instruction for outputting the list generated by the list generating means, and the output means outputs detailed information about a traffic disturbance shown by traffic information included in the list according to the instruction from said output instruction means.

9. The vehicle-mounted navigation apparatus according to claim 1, characterized in that the control means filters traffic information about an area along the route searched for by the route searching unit, the traffic information being included in the traffic information acquired by the traffic information acquiring means, according to the conditions set up by the conditions setting means so as to extract traffic information according to these conditions.

10. The vehicle-mounted navigation apparatus according to claim 1, characterized in that the control means filters traffic information about a certain area extending from the vehicle position detected by the position detecting means, the traffic information being included in the traffic information acquired by the traffic information acquiring means, according to the conditions set up by the conditions setting means so as to extract traffic information according to these conditions.

11. The vehicle-mounted navigation apparatus according to claim 1, characterized in that the position detecting means detects a traveling direction of the vehicle, and the control means filters traffic information about a certain area extending in the travelling direction detected by the position detecting means, the traffic information being included in the traffic information acquired by the traffic information acquiring means, according to the conditions set up by the conditions setting means so as to extract traffic information according to these conditions.
